(19) United States
(12) Patent Application Publication
(10) Pub. No.: US 2012/0221296 A1
(43) Pub. Date: Aug. 30, 2012

(54) Method for signal decomposition

(76) Inventor: Liang Fu, Potomac, MD (US)

(21) Appl. No.: 13/035,963

(22) Filed: Feb. 26, 2011

(51) Int. Cl. G06F 19/00

(52) U.S. Cl. 702/190

(57) ABSTRACT

A method for signal decomposition, Separation-Estimation (SE) method, is introduced. The SE method has a broad scope: it applies to signals of arbitrary form (scalar, vector, tensor, real, complex, etc.) of arbitrary composition of arbitrary components. Through a novel iterative process, the SE systematically and reliably completes all four tasks of signal decomposition. The SE method can handle signals with strong component interactions. It is flexible, efficient, robust, and has strong noise resistance. The SE method overcomes most of the limitations of the existing signal decomposition methods.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to signal decomposition, especially methods and algorithms for signal decomposition.

2. Introduction

A composed signal or function y(x) in general can be modeled as

y(x)=m(x)=C[f₁(x,α₁),f₂(x,α₂), . . . ,f_{M}(x,α_{M})] (1)

In equation (1), fₘ(x,αₘ) (m=1, 2, . . . M) models the m-th underlying component hence will be called the component model for the m-th component. C is a composition operator, which composes a set of Mcomponent models in a predetermined manner to form the model m(x). Each component model fₘ(x,αₘ) represents a function family with parameter αₘ, which can be a scalar (single parameter), a vector (consists of a set of scalar parameters), or tensor (also consists of a set of scalar parameters). The parameters can be real or complex. The signal and all component models can be scalar, vector, tensor, real, complex, etc.

For clear distinction from the partial signal and partial model that will be introduced later, the signal y(x), which includes the contributions of all underlying components, will be called the full signal. The model m(x), which is composed of all component models, will be called full model. Correct full model must have correct number of component and the correct component models for all components.

The full signal and the component models do not have to be in closed form or a continuous function. Furthermore, the full signal does not have to be directly measured signal but can be a suitable transformation of the measured signal. The composition can also be hierarchical, meaning that some or all of the components in turn are composed of lower level components and so on.

Equation (1) includes all possible (arbitrary) types of compositions, and a particular case is the linear composition (where the composition operator performs addition)

y(x)=Σₘ₌₁^{M}Aₘfₘ(x,αₘ) (2)

Following the convention for linear composition, the parameters Aₘ (the amplitude or partition) are written explicitly.

For a signal decomposition problem, often a set of samples of the full signal at N discrete sample points xₙ, (n=1, 2, . . . , N) is given. The objective of the signal decomposition is to determine the underlying components from the given samples of the full signal. More precisely, the adjustable parameters are determined such that the full model best fit the full signal at the sampled points according to predetermined criteria. The fitting can be expressed mathematically as

y(xₙ)≐m(xₙ),(n=1,2, . . . ,N) (3)

where the sign ≐ means best fit according to predetermined criteria. Signal decomposition sometimes is called function decomposition or inverse in the literature.

The adjustable (to-be-determined) parameters can generally be divided into two groups: linear and nonlinear parameters. A parameter is a linear parameter if the full model linearly depends on it. Otherwise it is a nonlinear parameter. Signal decomposition problems usually involve at least one nonlinear parameter.

Signal decomposition brings about two major benefits. Firstly, it let us gain insight into the system that produces the signal. Secondly, it condenses the signal into a set of components and parameters. Because of these benefits, signal decomposition concerns many areas of science, engineering, and technology.

For example, for many systems, whether mechanical, electrical, or biological, the system output (signal) reflects the behavior of some hidden system variables (hidden states). These hidden system variables describe the system properties, and it is desirable to determine them based on the system output. In signal processing, a signal often has multiple sources or contains multiple features, and it is desirable to identify or to separate the sources or features. In pattern recognition and machine learning, it is often desirable to identify and determine objects with different properties and group similar objects.

In communication and storage, signal decomposition allows us to condense the signal into a set of components and parameters, substantially reducing the burden of transmission and storage.

In statistics, samples are often drawn from several underlying populations, each having its own statistics. So the sample distribution should be modeled by a linear composition of several individual distributions, each describing an underlying population. Such model is called Finite Mixture Model (FMM). A popular example of FMM is the Gaussian mixture model (GMM). Decomposing FMM, namely, determining the underlying components of the mixture model, is an important branch of statistics.

Clustering aggregates samples of close properties, which has broad applications in many areas of sciences, engineering, and technologies. Although in most FMM and clustering problems a set of discrete random samples is given, FMM and clustering essentially decompose the distribution of the discrete random samples. Therefore, FMM and clustering are also within the realm of signal decomposition.

A general and complete signal decomposition process includes four tasks

(T1) determining the number of the components;
(T2) determining component models for all components;
(T3) obtaining initializations for the adjustable parameters; and
(T4) determining the adjustable parameters.

Each of the four tasks represents a link in the signal decomposition chain. If any one of them is not completed satisfactorily, the entire signal decomposition fails. In particular, the first three tasks (T1)-(T3) must ALL be completed satisfactorily in order to complete the last task (T4) correctly.

If one proposes a full model with fewer components than necessary, some components (often the weak ones) will be lost and the rest components will be estimated inaccurately. Conversely, if one proposes a full model with more components than necessary, fake components will be produced and the rest components will be estimated inaccurately. Not only that, the excess freedom in the full model could render the results meaningless. Wrong component model for a specific component can upset the entire decomposition. Poor initialization can produce wrong results (corresponding to local optima of the objective function) or no results (singularity or divergence). And poor initialization severely prolongs the optimization process even if the global optimum is eventually reached.

On the other hand, if the first three tasks have been completed satisfactorily, one has the correct full model and high quality initialization for all parameters, the last task can be completed easily by many existing optimization or data modeling methods. It is not an overstatement that a signal decomposition problem is essentially solved if the first three tasks are completed satisfactorily. Presently, the research on signal decomposition method and algorithm essentially focuses on the first three tasks. A signal decomposition method is evaluated essentially by its scope (forms of signal, types of composition, and types of components it can handle) and how well it completes the first three tasks.

### BACKGROUND OF THE INVENTION

### Prior Art

Because of the broad applications of signal decomposition, the research on signal decomposition has been extremely active and many signal decomposition methods have been developed. Nevertheless, the existing signal decomposition methods have severe limitations.

Many existing signal decomposition methods can only complete the last task (T4). These methods are often called supervised methods. In fact, none of the existing signal decomposition methods can systematically and reliably complete the first three tasks (T1)-(T3).

For task (T3), the existing methods generally use two approaches. The first approach relies on visual inspection of the full signal and its various projections (for dimension reduction, so the full signal can be presented visually). Visual inspection is unreliable, and is limited to the cases where the components are well separated. Furthermore, visual inspection is manual, labor and time consuming, and is extremely difficult if not impossible for high dimensional space. The second approach is arbitrary or random initialization, which has a high failure rate. In order for the optimization process to succeed, all parameters must be initialized in a manner such that the optimization process avoids the traps of all local optima and converges to the global optimum. When the number of components is large and/or the number of parameters per component is large (e.g., high dimensions and/or complex models), the chance for arbitrary or random initialization to succeed is very slim. Again, arbitrary or random initialization is time and labor consuming, because they involve large number of trials. For a given signal decomposition problem, there are often infinitely many possible initializations. Even one has tried a large set of different arbitrary or random initializations, there is no guarantee to reach the global optimum.

For task (T2), at present, it is always assumed that the underlying components are of one known type and task (T2) is never addressed. This poses a severe limitation, since many practical systems have diverse components.

For task (T1), the existing methods generally use two approaches. The first approach again relies on visualization, where one determines the number of components by visually inspecting the full signal or its various projections. Clearly, visual inspection is unreliable and is basically limited to problems in low dimensions and with well separated components. Furthermore, visual inspection is manual, time and labor consuming. The second approach is based on trial and error, where one repeats the decomposition process with trial full models of different number of components, while monitoring the fitting result, which is often measured by an objective (or error) function. When the objective function or the change of it falls below a predetermined threshold, the corresponding number of components is deemed as optimal. A variation of this is to design a score, which is basically the objective function plus a penalty term that penalizes the mode complexity. Again one repeats the decomposition process with different number of components and monitors the score. The number of components that corresponds to the optimal score is deemed as optimal.

Note that the choice of threshold or the penalty term is subjective. A high threshold or strong penalty term generally favors fewer components, while a low threshold or weak penalty term favors more components. Many different scores have been proposed, and they often disagree with each other for the same signal decomposition problem.

More importantly, the trial and error approach hinges on the optimization of the objective function (with or without the penalty term). If the optimization does not converge to the global optimum for any reason (for example, poor initialization), the result is meaningless. As discussed earlier, presently, there is no systematic and reliable method for obtaining good initialization, especially if the number of components is unknown. Furthermore, even if one has conducted a large number of trials with different number of components and different initializations, there is no guarantee that the trial model with the best result is correct model.

The degree of difficulty of a signal decomposition problem is mainly determined by the component interaction (interference). Qualitatively, component interaction is characterized by overlap and/or disparity of the components. The more overlap and/or the greater the disparity is, the stronger the component interaction is. If all components are well separated, the decomposition will be very easy since one can determine the components separately. Quantitatively, component interaction can be measured by Fisher criterion. The smaller the Fisher criterion is, the stronger the component interaction is.

Component interaction affects all four tasks of signal decomposition. With strong component interaction, components cover each other, making it difficult to determine the number of components, to determine the component models, to obtain good initialization, and to determine the adjustable parameters.

Strong component interaction particularly hinders the existing signal decomposition methods. Firstly, strong component interaction makes visualization very difficult if not impossible. Secondly, strong component interaction significantly reduces the success rate of random trials. Generally speaking, the stronger the component interaction is, the more local optima there are and the more difficult it is to reach the global optimum.

The CLEAN algorithm, although devised for a completely different purpose, deserves mentioning. The original CLEAN algorithm was introduced in 1974 by J. A. Hogbom (“Aperture synthesis with a non-regular distribution of interferometer baselines”, Astron. Astrophys. Suppl. 15, pp. 417-426, 1974, hereafter Hogbom74), which concerns a Two-Dimensional (2D) full signal of Linear Composition of Complex Harmonic Oscillations (LCCHO)

y(u,v)=Σₘ₌₁^{M}Aₘe^{i(x}^{ₘ}^{u+y}^{ₘ}v) (4)

where each component (a complex harmonic oscillation) corresponds to a point source in the sky: the parameters (xₘ, yₘ) represent the angle of arrival and Aₘ represents the brightness.

A synthesized interferometer image is constructed by a 2D Fourier transform of the full signal in equation (4). With sufficient sampling, the Fourier transform of a complex harmonic oscillation appears as a sharp peak (spike), so a point source indeed appears as a point on the image. Unfortunately, due to insufficient sampling, a point source appears as a broadened peak with a finite (height and width) mainlobe and spreading sidelobes. So every point source is smeared and the image appears “dirty”. The CLEAN algorithm, through an iterative subtraction process, removes the smear hence “cleans” the dirty image. The original CLEAN algorithm is listed in FIG. 1.

Discrete samples of a signal can also be viewed as the ideal (continuous) signal multiplied by a window function (termed “dirty beam” in Hogbom74) which has value one at all sampled points and value zero everywhere else. According to the Fourier transform theorem, the dirty image is the convolution of the Fourier transform of the window function and that of the ideal signal. With such viewpoint, removing the effect of insufficient sampling (the smear) is equivalent to “deconvolute” the dirty beam out of the Fourier transform of the full signal. Therefore, CLEAN algorithm is often considered as a deconvolution technique in literature.

Some variations of the original CLEAN algorithm have been patented. For example, U.S. Pat. No. 5,394,151 claims a 3D version of CLEAN algorithm. U.S. Pat. Nos. 7,042,386, 7,215,277, and U.S. patent application Ser. Nos. 10/833,342, 11/294,379 introduce a variation of CLEAN algorithm for sub-aperture images, where additional steps for sub-aperture processing are added to the original CLEAN algorithm. U.S. Pat. No. 5,862,269 introduces a variation of CLEAN algorithm, named FASTCLEAN, where the sequential processing is relaxed: in each iteration cycle, all peaks within a given range are processed. In contrast, the original CLEAN algorithm processes only one peak in each iteration cycle.

P. T. Gough introduced a modified version of CLEAN algorithm for 1D in 1994 (“A fast spectral estimation algorithm based on the FFT”, IEEE Trans. Signal Process., Vol. 15, No. 6, pp. 1317-1322, 1994, hereafter Gough94). Gough's algorithm is listed in FIG. 2. Note that although Gough94 appears to consider real harmonic oscillations, it does not provide a viable method for estimating real harmonic oscillations, which is of particular difficulty (see below). It is therefore assumed that Gough's algorithm considers LCCHO and uses FTPPE, just like the original CLEAN algorithm. Differing from the original CLEAN algorithm, Gough's algorithm (a) subtracts the whole estimated component (λ=1), and (b) re-estimates all previously estimated components [see (v)-(viii) of FIG. 2] in every iteration cycle after a new component is estimated.

A further variation of Gough's algorithm was introduced by J. Li et al. in 1996 (“Efficient mixed-spectrum estimation with application to feature target extraction”, IEEE Trans. Signal Process., Vol. 44, No. 2, pp. 281-295, 1996, hereafter Li96). This algorithm, named RELAX in Li96, also concerns 1D LCCHO and is listed in FIG. 3. RELAX algorithm only differs from Gough's algorithm in one step [marked (*) in FIG. 3]. Recall that in every iteration cycle of Gough's algorithm the components are re-estimated once, RELAX algorithm pushes it further: the components are re-estimated sequentially multiple times until “practical convergence” is achieved.

To ease the description, from now on the original CLEAN algorithm and all its variations (including all examples discussed above) will be called as CLEAN type algorithms.

Even though Gough's algorithm and RELAX algorithm re-estimate the components, these algorithms do not completely guarantee a one-to-one correspondence between the estimated components and the underlying components, since the residual of an inaccurately estimated component could appear as one or more smaller components. This problem is particularly prominent in the early stage of iteration. This is not a real problem for cleaning synthesized interferometer image, but it can be a serious problem if the CLEAN type algorithms are used for signal decomposition, since the wrong number of components can completely ruin the signal decomposition. None of the CLEAN type algorithms (including Gough's algorithm and RELAX algorithm) provide a remedy to this problem.

The parameters (xₘ, yₘ) for a harmonic oscillation are nonlinear parameters. CLEAN type algorithms cleverly explore a unique property of complex harmonic oscillation and utilize a unique method to estimate these nonlinear parameters. For definiteness, this method will be called Fourier Transform Peak Point Estimation (FTPPE) method.

FTPPE is the foundation for CLEAN type algorithms. It is based on the assumption that the full signal is of the form of LCCHO. A single component of a 2D LCCHO, namely, y(u, v)=A₀e^{i(x}^{₀}^{u+y}^{₀}^{v)}, is a single complex harmonic oscillation. Assuming the available measurements (sampling) are μₗ=lΔu(l=0, 2, . . . , L−1)vₘ=mΔv(m=0, 2, . . . , M−1), the Fourier transform of y(u, v) is

$$Y ( {k}_{x} , {k}_{y} ) = \frac{1}{LM} {\sum }_{l = 0}^{L - 1} {\sum }_{m = 0}^{M - 1} {A}_{0} {e}^{i ( {x}_{0} {u}_{l} + {y}_{0} {v}_{m} )} {e}^{- i ( {k}_{x} {u}_{l} + {k}_{y} {v}_{m} )} = {A}_{0} \frac{1}{L} \frac{1 - {e}^{i L Δ u ( {k}_{x} - {x}_{0} )}}{1 - {e}^{i ( {k}_{x} - {x}_{0} )}} \frac{1}{M} \frac{1 - {e}^{i M Δ u ( {k}_{y} - {y}_{0} )}}{1 - {e}^{i Δ u ( {k}_{y} - {y}_{0} )}} \qquad ( 5 )$$

The magnitude of the Fourier transform, namely, |Y(kₓ, k_{y})|, has a main peak at kₓ=x₀ and k_{y}=y₀, at which Y(x₀, y₀)=A₀.
Therefore, the unknown parameters (x₀, y₀) can be estimated by
(a) Compute the Fourier transform Y(kₓ, k_{y}) of sampled y(u, v);
(b) Search the peak of Y(kₓ, k_{y}), the peak position yields (x₀, y₀);
(c) Compute A₀ using Y(x₀, y₀)=A₀.
This is the FTPPE method.

Clearly, FTPPE only applies to SINGLE complex harmonic oscillation. In fact, the basic idea of the CLEAN type algorithms is to separate the components (complex harmonic oscillations) so that the FTPPE can be used. This implies that CLEAN type algorithms can only work in a sequential fashion, namely, the components can only be estimated one at a time. Therefore, the FASTCLEAN algorithm (U.S. Pat. No. 5,862,269) has no theoretical basis. Indeed, the only effect of FASTCLEAN is to delay the update of the estimates.

It must be emphasized that FTPPE does not apply to REAL harmonic oscillation. A real harmonic oscillation can be expressed as a pair of conjugated complex harmonic oscillations

$$z ( u , v ) = {B}_{0} cos ( ϕ + {x}_{0} u + {y}_{0} v ) = \frac{{B}_{0} {e}^{i ϕ}}{2} {e}^{i ( {x}_{0} u + {y}_{0} v )} + \frac{{B}_{0} {e}^{- i ϕ}}{2} {e}^{- i ( {x}_{0} u + {y}_{0} v )} \qquad ( 6 )$$

Note that the conjugate pair is inseparable, hence there is always interaction (overlap) between them, especially with insufficient sampling. Such interaction will be called auto interaction. The Fourier transform of z(u, v) is

$$Z ( {k}_{x} , {k}_{y} ) = \frac{{B}_{0} {e}^{i ϕ}}{2} \frac{1}{L} \frac{1 - {e}^{i L Δ u ( {k}_{x} - {x}_{0} )}}{1 - {e}^{i ( {k}_{x} - {x}_{0} )}} \frac{1}{M} \frac{1 - {e}^{i M Δ u ( {k}_{y} - {y}_{0} )}}{1 - {e}^{iΔ u ( {k}_{y} - {y}_{0} )}} + \frac{{B}_{0} {e}^{- i ϕ}}{2} \frac{1}{L} \frac{1 - {e}^{i L Δ u ( {k}_{x} + {x}_{0} )}}{1 - {e}^{i ( {k}_{x} + {x}_{0} )}} \frac{1}{M} \frac{1 - {e}^{i M Δ u ( {k}_{y} + {y}_{0} )}}{1 - {e}^{iΔ u ( {k}_{y} + {y}_{0} )}} \qquad ( 7 )$$

|Z(kₓ, k_{y})|. Because of the auto interaction, the two main peaks of |Z(kₓ, k_{y})| are not at ±(x₀, y₀) and the corresponding Z(kₓ, k_{y}) at the two main peaks do not equal to B₀e^{±Iφ}/2. In other words, the conjugate pair or the real harmonic oscillation cannot be determined accurately determined by FTPPE. In the worst case scenario, the two peaks may even merge to one peak at (0,0), and the results of FTPPE is meaningless. Using FTPPE to determine a real harmonic oscillation is conceptually incorrect. It should be noted that Gough94 realizes the problem of auto interaction between the two conjugates (see the end of page 2 of Gough94), it does not provide any solution to this problem. In fact, Gough94 does not even mention how the components are estimated.

All measured signals are real. A complex signal is synthesized from quadrature signals (a pair of real signals, one becomes the real part and the other becomes the imaginary part of the complex signal). Because the quadrature signal is usually unavailable in practice, the scope of FTPPE is very limited.

Since all CLEAN type algorithms are based on FTPPE, they incorporate the same limitations. Despite the development in the last several decades since the introduction of the original CLEAN algorithm, no CLEAN type algorithm goes beyond LCCHO, not even to Linear Composition of Real Harmonic Oscillations (LCRHO).

It should be noted that LCCHO in general include the signals of the form

Y(x)=Σₘ₌₁^{M}Aₘ(γₘ)e^{ik}^{ₘ}^{(β}^{ₘ}^{)·x} (8)

where Aₘ(γₘ) and kₘ(βₘ) (m=1, 2, . . . , M) are known functions and are invertable, which means that the parameters γₘ and βₘ can be uniquely determine if the values of Aₘ(γₘ) and kₘ(βₘ) are known. Note that this is a very restrictive condition. For this type of signals one simple treat Aₘ(γₘ) and kₘ(βₘ) as parameters in the signal decomposition process and determine γᵢₙ and βₘ at the end by inverting Aₘ(γᵢₙ) and kₘ(βₘ).

Further examples of the CLEAN type algorithms and/or applications of them include U.S. Pat. Nos. 5,299,577, 5,383,457, 5,784,492, 6,781,540, 7,302,269, 7,315,281, 7,618,774, and U.S. patent application Ser. No. 10/992,595, 11/925,887. Since they all use FTPPE, hence, they apply only to LCCHO.

The literatures on CLEAN type algorithms often do not state clearly their scopes. Some may leave an impression that they can be applied to any component as long as its Fourier transform has a peak, which is certainly false. Others may leave an impression that they can be applied to LCRHO (Gough94 is an example). As proved above, CLEAN type algorithms apply only to LCCHO and can only work in a sequential fashion.

In view of the foregoing background, the existing signal decomposition methods have the following limitations.

(L1) They cannot handle signals of arbitrary forms (most of them are limited to scalar signals);
(L2) They cannot handle signals of arbitrary composition (most of them are limited to linear compositions);
(L3) They cannot handle signals composed of arbitrary components (most of them apply to a specific type of component);
(L4) They cannot systematically and reliably determine the number of underlying components;
(L5) They cannot systematically and reliably determine the component models;
(L6) They cannot systematically and reliably obtain the initialization;
(L7) They cannot handle strong component interactions.
Given the broad applications of signal decomposition and active researches on the topic, any improvement that alleviates any of these limitations should be considered significant.

### SUMMARY OF THE INVENTION

It is an objective of the present invention to provide a signal decomposition method that applies to signals of arbitrary form (scalar, vector, tensor, complex, real, etc.).

It is another objective of the present invention to provide a signal decomposition method that applies to signals of arbitrary composition.

It is yet another objective of the present invention to provide a signal decomposition method that applies to signals composed of arbitrary components.

It is yet another objective of the present invention to provide a signal decomposition method that can systematically and reliably complete all four tasks of signal decomposition.

It is yet another objective of the present invention to provide a signal decomposition method that can handle strong component interaction.

### BRIEF DESCRIPTION OF THE DRAWINGS

FIG. 1 presents the original CLEAN algorithm.

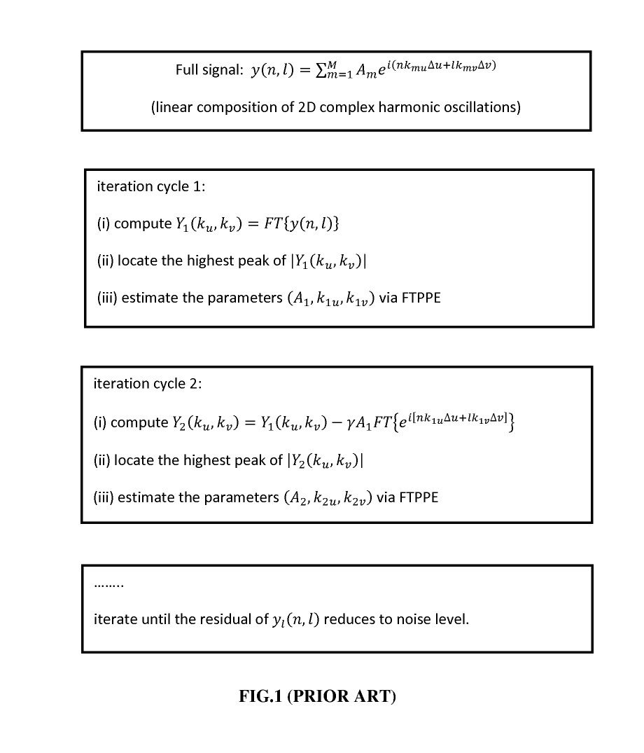

FIG. 2 presents Gough's algorithm (a CLEAN type algorithm).

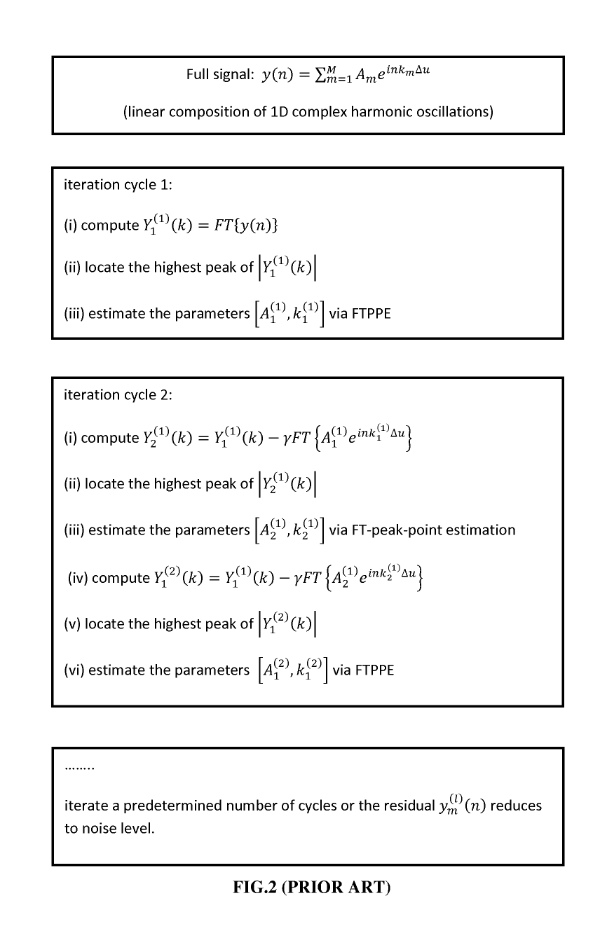

FIG. 3 presents the RELAX algorithm (a CLEAN type algorithm).

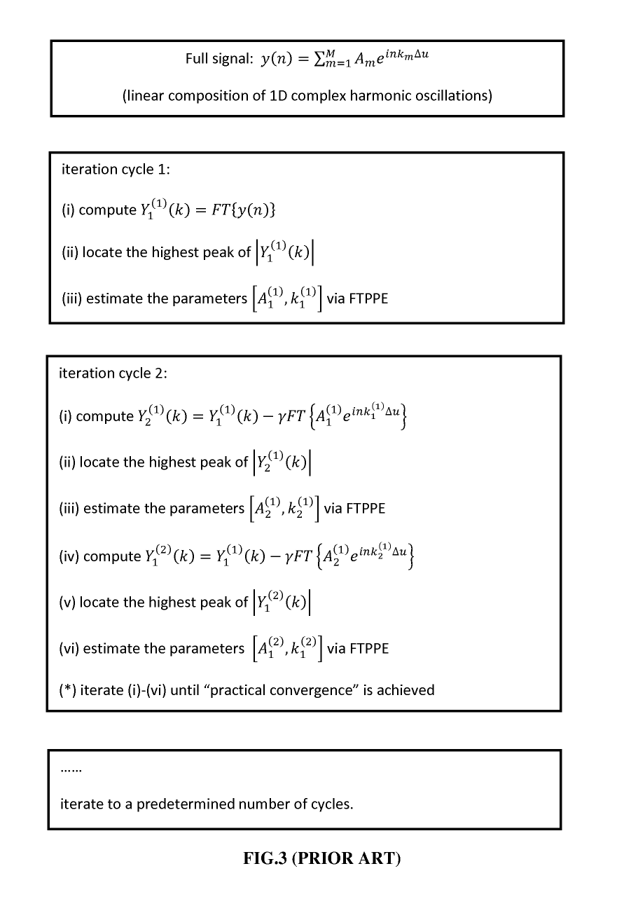

FIG. 4 presents one embodiment of the SE method (The two-step form).

FIG. 5 presents another embodiment of the SE method (SEEM form).

FIG. 6 presents another embodiment of the SE method (relaxed SEEM form).

FIG. 7 presents yet another embodiment of the SE method (SE-MLE).

FIG. 8 presents yet another embodiment of the SE method (relaxed SE-MLE).

FIG. 9 shows the difference between the SEEM and a set of trial full models in model space.

### DETAILED DESCRIPTION OF THE PRESENT INVENTION

### Definitions and Notations

### Decomposition Operator

Unlike any existing signal decomposition method, the SE method applies to arbitrary compositions. We have introduced the composition operator in equation (1), which allows arbitrary composition of arbitrary components. To facilitate decomposition of signals of arbitrary composition of arbitrary components, we further introduce a decomposition operator. A decomposition operator is always associated with a composition operator. A decomposition operator D takes one operand (function) to its left and one or more operands to its right, and generates a new function

z(x)=y(x₁,x₂, . . . ,x_{K})D[g₁(x),g₂(x), . . . ,gₗ(x), . . . ]. (9)

The decomposition operator D “removes” (reverse of composition) the operands to its right from the operand to its left. The following are some examples.

If a composition operator performs addition, the corresponding decomposition operator performs subtraction:

$$\{ \begin{matrix}y ( x ) = C [ {f}_{1} ( x ) , {f}_{2} ( x ) , … , {f}_{M} ( x ) ] ≡ {\sum }_{m = 1}^{M} {f}_{m} ( x ) \\ z ( x ) = y ( x ) D [ {g}_{1} ( x ) , {g}_{2} ( x ) , … , {g}_{L} ( x ) ] ≡ y ( x ) - {\sum }_{l = 1}^{L} {g}_{l} ( x )\end{matrix} \qquad ( 10 )$$

If a composition operator performs multiplication, the corresponding decomposition operator performs division:

$$\{ \begin{matrix}y ( x ) = C [ {f}_{1} ( x ) , {f}_{2} ( x ) , … , {f}_{M} ( x ) ] ≡ {\prod }_{m = 1}^{M} {f}_{m} ( x ) \\ z ( x ) = y ( x ) D [ {g}_{1} ( x ) , {g}_{2} ( x ) , … , {g}_{L} ( x ) ] ≡ y ( x ) / {\prod }_{l = 1}^{L} {g}_{l} ( x )\end{matrix} \qquad ( 11 )$$

If a composition operator performs multiplication followed by inversion, the corresponding decomposition operator performs division followed by inversion:

$$\{ \begin{matrix}y ( x ) = C [ {f}_{1} ( x ) , {f}_{2} ( x ) , … , {f}_{M} ( x ) ] ≡ arcos [ {\prod }_{m = 1}^{M} {f}_{m} ( x ) ] \\ z ( x ) = y ( x ) D [ {g}_{1} ( x ) , {g}_{2} ( x ) , … , {g}_{L} ( x ) ] ≡ arcos [ {\prod }_{m = 1}^{M} {f}_{m} ( x ) / {\prod }_{l = 1}^{L} {g}_{l} ( x ) ]\end{matrix} \qquad ( 12 )$$

In general, the effect of the corresponding decomposition operator can be determined as follows.

(i) Observe how the composition operator “adds” a single component (here, “add” means to include the contribution of the component into the signal);
(ii) Determine the operation that precisely cancels the effect of the composition operator in step (i), such operation is what the decomposition operator does to decompose a single component (removing the contribution of the component from the signal);
(iii) Repeatedly apply the decomposition operator for each of the components to be decomposed (the operand on the right of the decomposition operator), one at a time.

### Classification of Components

Underlying component: an underlying component is a component that contributes to the full signal.

Target component: a target component is a component that at least one of its parameters we desired to estimate or re-estimate.

Separation component: a separation component is a component used in the computation of the partial signal.

Considered component: a considered component is a component that is taken into the computation (non-considered components are treated as non-existent). A considered component is either a separation component or a target component.

As the process progresses, the role of an underlying component may change. It can be a non-considered component, a target component, or a separation component in different iteration cycles.

### EXEMPLARY EMBODIMENTS OF THE PRESENT INVENTION

The signal decomposition method of the present invention will be called as Separation-Estimation (SE) method. The SE method is an iterative method. Differs from any existing signal decomposition method, which is always limited to a particular type (often linear) of composition and a particular type of components, the SE method applies to signals of arbitrary composition of arbitrary components. The introduced composition and decomposition operators facilitate that. The SE method can have many different forms or embodiments. A few exemplary embodiments are provided bellow.

### Two-Step Form of the SE Method

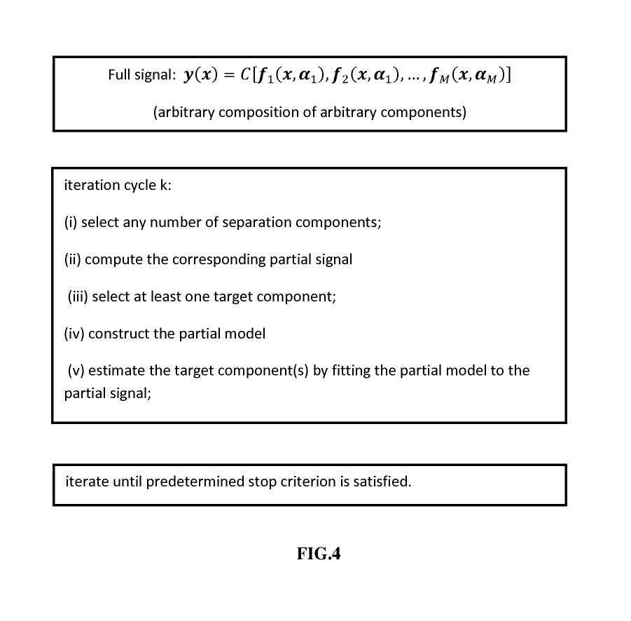

Refer to FIG. 4 for one embodiment of the SE method. As shown in FIG. 4, the full signal y(x) is of the most general form as in equation (1). In this embodiment, each iteration cycle of the SE method consists of a Separation step (S-step) and an Estimation step (E-step). Hence, it will be called the two-step form of the SE method.

### (i) S-Step [Item (i) and (ii) of FIG. 4]:

Select I(≧0) separation components (for definiteness, we label the separation components from s₁ to s_{I}), and compute the partial signal that is defined as

yₚ(xₙ)=y(xₙ)D{fₛ_{₁}[xₙ,αₛ_{₁}^{(p)}],fₛ_{₂}[xₙ,αₛ_{₂}^{(p)}], . . . ,fₛ_{_{I}}[xₙ,αₛ_{_{I}}^{(p)}]},(n=1,2, . . . ,N), (13)

where the superscript (p) indicates previous estimates. Note that if no separation component is selected (I=0), the partial signal is the full signal.
(ii) E-Step [Item (iii) to (v) of FIG. 4]:

Select L(≧1) target components (for definiteness, we label the target components from t₁ to t_{L}), construct a partial model

m_{P}(x)=C{fₜ_{₁}[x,αₜ_{₁}^{(a)}],fₜ_{₂}[x,αₜ_{₂}^{(a)}], . . . ,fₜ_{_{L}}[x,αₜ_{_{L}}^{(a)}]}, (14)

and fit the partial model to the partial signal at the sampled points. The superscript (a) indicates adjustable parameters (those we desire to estimate in this step).

The above procedure (S-step and E-step) are iterated until predetermined stop criterion (or criteria) is (are) satisfied. Examples of stop criterion include (but are not limited to) a predetermined number of iteration cycles, a predetermined number of components have been determined, all components that satisfy predetermined criteria have been determined, a predetermined threshold on a certain measurement of the partial signals, a predetermined threshold on a suitable objective function or score, a predetermined threshold on the change of the objective function or score, a predetermined threshold on the change of the parameters, etc. The actual stop criterion (or criteria) is (are) set by the user based on the specific decomposition problem.

It should be noted that practical signal decompositions do not always pursue completeness (determination of all underlying components) or perfection (e.g., maximum accuracy or absolute convergence). A practical signal decomposition problem may require a full decomposition (all components are determined) or partial decomposition (only a subset of the components are determined). Furthermore, it may require accurate estimation or rough estimation of the parameters. In some cases, it may require only a subset of the underlying components be detected (not even estimated). The actual requirements for a specific problem are reflected in the stop criteria.

By computing the partial signal, we remove the contribution of the separation components (based on their previous estimates) from the full signal. If the separation is complete, namely, (a) all underlying components are considered and (b) the previous estimates of the separation components are accurate, the partial signal will represent accurately the contribution of the target components to the full signal (apart from noise).

During the iteration, especially in the early stage of the iteration, the separation is usually incomplete: some underlying components may not be considered (they may not be detected yet), and/or the current estimations may not be accurate. If the separation is incomplete, the partial signal is an approximation of the contribution of the target components to the full signal.

Even if the separation is incomplete, the partial signal still provides great insight into the target components. Such insight helps us to complete the first three tasks (T1)-(T3) of signal decomposition. As discussed earlier, if the components are well separated, the first three tasks (T1)-(T3) will become much easier. The separation step of the SE method effectively provides such separation, although complete separation is achieved through iteration. The fundamental idea and spirit of the SE method is in its name: Separation-Estimation. Separation enables more accurate estimation, and estimation enables more complete separation. These two elements improve upon each other through iteration.

Furthermore, through separation, the SE method untangles the underlying components and gradually reduces and eventually removes the component interaction. Because of this reason, the SE method can decompose signals with strong component interaction. Since most existing signal decomposition method deal only with the full signal, they do not have the insight provided by the partial signal, and they cannot decompose signals with strong component interaction.

For the estimation step, the adjustable parameters of the partial model are estimated by fitting the partial model to the partial signal at the N sampled points xₙ(n=1, 2, . . . , N), (at which the full signal is sampled)

y_{P}(xₙ)≐m_{P}(xₙ),(n=1,2, . . . ,N). (15)

The adjustable parameters may be determined via an optimization process. Only a general procedure for optimization will be outlined below.

### Estimation by Optimization

The adjustable parameters can generally be estimated via an optimization process. For example, one selects a suitable partial error function of the general form

E_{P}=Σₙ₌₁^{N}e{y_{P}(xₙ),m_{P}(xₙ)} (16)

where e(y,m) is a non-negative function that measures the closeness of the two arguments.

If e(y,m)=∥y−m∥², the partial error function is the least-square error function. If e(y,m)=∥y−m∥, the partial error function is the absolute error function. There are endless choices for e(y,m) and cannot be listed one by one.

The adjustable parameters αₜ_{₁}^{(a)}, αₜ_{₂}^{(a)}, . . . , αₜ_{_{L}}^{(a)} of the partial model are estimated by minimizing the partial error function. Now, the parameter estimation has been formulated as a minimization problem. There are several approaches to minimization problem.

For simple error functions, such as x-square, least-square, or absolute deviation, there exist efficient minimization methods such as Steepest descent method, Inverse-Hessian method, and Levenberg-Marquardt method. For minimizing general error functions, Downhill simplex method, Powell's method, Conjugate gradient method, and Variable metric method can be used.

For general error functions, one can also take the usual approach by requiring the first order derivatives of error function with respect to all parameters to vanish, which yields a set of (usually nonlinear) equations of the number of the parameters. The parameters are then determined by solving simultaneously the equations. The numerical methods for solving nonlinear equations include Newton-Raphson method and Secant method (Bryden's method).

The skilled in the art should appreciate that optimization may be used by the SE method for the estimation step but it is not an essential element of the SE method. There are many other ways for estimation.

### Handling Constraints

In some cases the model must satisfy certain conditions. In other words, there are some constraints on the parameters. Mathematically, constraints can be expressed in the form of equations or inequalities, such as

gᵢ(α₁,α₂, . . . ,α_{M})=0,(i=1,2, . . . ),hⱼ(α₁,α₂, . . . ,α_{M})≧0,(j=1,2, . . . ) (17)

These constraints must be taken into account in parameter estimation. Generally speaking, the equation type constraints can be handled by substitution and elimination or by Lagrange multipliers. The inequality type of constraints usually requires specialized methods. The skilled in the art should appreciate that the constraint handling is independent of the SE method, and any suitable method may be used with the SE method.

Although in the above we have formulated the parameter estimation problem into a minimization problem, we can equally formulate it into a maximization problem or any other optimization problem. For example, one can simply use the negative of the error function, then, the estimation problem becomes a maximization problem. Generally speaking, one select a suitable objective function (also called merit function, cost function, etc. in the literature) and determines the adjustable parameters by optimizing (maximizing or minimizing) the objective function. The partial objective function provides a measure on how well the partial model fits the partial signal. It can be used to evaluate the correctness of the partial model (the correctness of the component models for the target components).

Clearly, the SE method as described above can be applied to signals of arbitrary form (scalar, vector, tensor, real, complex), of arbitrary composition, and of arbitrary components.

### Use of the SE Method

We provide a simple example to illustrate the use of the SE method. This example shows only one of the countless possible ways to execute the SE method. Therefore, any aspect of this example should not be construed as any limitation of the SE method. Starting from the first iteration cycle, where there is no separation component (l=0) hence the partial signal is the full signal. From the partial signal, usually one or more underlying components (the strongest components) can be detected. Among them, at least one target component is selected. Based on the behavior of the target component, a component model is selected, and the partial model is constructed. The partial model is fitted to the partial signal at the sampled points and the adjustable parameters of the partial model are estimated.

In the second iteration cycle, one may select all components that have been estimated in the previous cycle as separation components. By computing the partial signal, the contributions of these separation components are removed. The resultant partial signal will reveal more underlying components. From them, at least one target component is selected and estimated. Alternatively, one may select some of the newly revealed components together with all (or some of) the previously estimated components as target components and estimate them together. The iteration proceed until the stop criterion (or criteria) is (are) met.

The freedom of selecting different separation components and the target components at each iteration cycle provides great flexibility. In most iterative methods, the iteration cycles are identical with the same predetermined tasks. In contrast, the iteration cycles of the SE method can change dynamically as needed. For example, by selecting the separation components and the target components, one can re-estimate any previous component to any extend (one time, several times, or until predetermined stop criterion (criteria) is (are) satisfied). Whether, when, and how to re-estimate the components should be decided based on the actual signal decomposition problem. In some cases, it may be more effective to re-estimate the previous components as a new component is estimated. In other cases, it may be more effective to re-estimate the components after all components are found. Most of the CLEAN type algorithms have rigid procedure for re-estimation (see, for example, Gough's algorithm and RELAX algorithm). Furthermore, as explained previously, the CLEAN type algorithms can only process one component at a time. In contrast, with the SE method, any number of target components can be estimated in an iteration cycle.

### SEEM Form of the SE Method

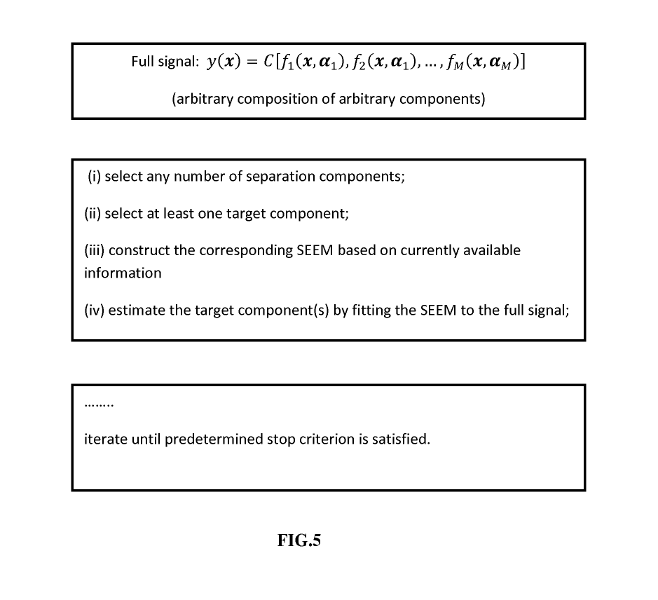

FIG. 5 presents another embodiment of the SE method. In each iteration cycle, select 1 (≧0) separation components (for definiteness, we label the separation components from s₁ to s_{I}) and L(≧1) target components (for definiteness, we label the target components from t₁ to t_{L}), construct the model

m_{E}(x)=C{fₛ_{₁}[x,αₛ_{₁}^{(p)}],fₛ_{₂}[x,αₛ_{₂}^{(p)}], . . . ,fₛ_{_{I}}[x,αₛ_{_{I}}^{(p)}],fₜ_{₁}[x,αₜ_{₁}^{(a)}],fₜ_{₂}[xₙ,αₜ_{₂}^{(a)}], . . . ,fₜ_{_{L}}[xₙ,αₜ_{_{L}}^{(a)}]}, (18)

and fit this model to the full signal to estimate the adjustable parameters.

The model m_{E}(x) evolves through the process of the SE method, which will be called Separation-Estimation Evolving Model (SEEM). SEEM is constructed based on the currently available information and is updated as new information becomes available. The information includes estimates of the parameters, the number of components, the component model, etc. The above procedure is iterate until predetermined criterion (criteria) is (are) satisfied. Through iteration, SEEM is built gradually, and eventually it evolves to the correct full model with correct parameters. This form of the SE method will be called the SEEM form of the SE method.

In the SEEM form of the SE method, an iteration cycle is not clearly divided into a separation step and an estimation step. Nevertheless, the SEEM form of the SE method is based on the fundamental idea and spirit of the SE method: the separation components [marked by superscript (p)] are for separation, while the target components [marked by superscript (a)] are for estimation. Although in the SEEM form of the SE method a partial signal is not required, it is often beneficial to compute the partial signal since it provides important insight into the underlying components.

### Relaxed SEEM

The SEEM defined in equation (18) is component based, the parameters of a component are either all fixed at previous estimates (for separation component) or all adjustable (for target component). This can be relaxed. Instead of separation components and target components, we consider separation parameters and target parameters. A separation parameter is fixed at its previous estimate, while a target parameter is adjustable (to-be-fitted). Accordingly, the relaxed SEEM (for definiteness, the considered components are labeled from 1 to K) is

m_{E}(x)=C{f₁[x,α₁^{(*)}],f₂[x,α₂^{(*)}], . . . ,f_{K}[x,α_{K}^{(*)}]} (19)

where K is the current number of considered components. The superscript (*) indicates that αₖ(*) may have adjustable (target) elements. If the i-th element of αₖ(*) is a separation parameter, it is fixed at previous estimate, otherwise, it is target parameter which is adjustable (we desire to estimate it in the current iteration cycle).

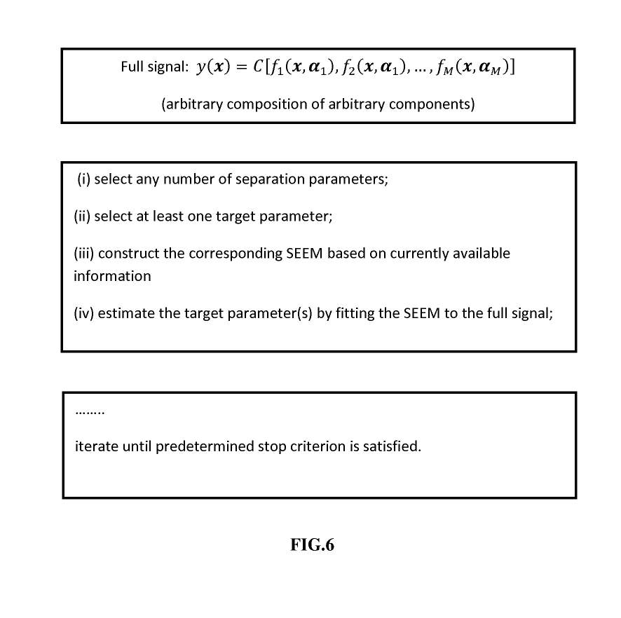

The version of the SE method with relaxed SEEM is presented in FIG. 6. Clearly, the SEEM defined in equation (18) is a particular case of the relaxed SEEM defined in equation (19). Therefore, the version of SE method in FIG. 5 is a particular case of that in FIG. 6.

### Linear Composition

Linear composition is a particular case of arbitrary composition. Although the above general form of the SE method covers linear composition, we provide explicitly the important elements of the SE method for linear composition.

Signal of linear composition is given by equation (2). The partial signal is given by

y_{P}(xₙ)=y(xₙ)−{Aₛ_{₁}^{(p)}fₛ_{₁}[xₙ,αₛ_{₁}^{(p)}]+Aₛ_{₂}^{(p)}fₛ_{₂}[xₙ,αₛ_{₂}^{(p)}]+ . . . +Aₛ_{_{I}}^{(p)}fₛ_{_{I}}[xₙ,αₛ_{_{I}}^{(p)}]},(n=1,2, . . . ,N) (20)

The partial model is given by

mₚ(x)=Aₜ_{₁}^{(a)}fₜ_{₁}[x,αₜ_{₁}^{(a)}]+Aₜ_{₂}^{(a)}fₜ_{₂}[x,αₜ_{₂}^{(a)}]+ . . . +Aₜ_{_{L}}^{(a)}fₜ_{_{L}}[x,αₜ_{_{L}}^{(a)}] (21)

The SEEM is given by

m_{E}(x)=Σₘ₌₁^{K}Aₘ^{(*)}fₘ[x,αₘ] (22)

### SE Method for Discrete Random Samples

In statistics, it occurs quite often that collected samples are from several underlying (often unknown) populations with distinct statistical properties. In such cases, the corresponding distribution should be modeled by a linear composition of several elementary distributions, each describing an underlying population

m(x)=Σₘ₌₁^{M}Aₘfₘ(x,αₘ) (22)

This is the full model for the distribution.
For definiteness, we assume that m(x) and all fₘ(x, αₘ) are normalized

∫m(x)dx=1,∫fₘ(x,αₘ)dx=1,(m=1,2, . . . ,M) (24)

Hence, the partitions (or weights) satisfy the partition constraint

Σₘ₌₁^{M}Aₘ=1 (25)

It is often desirable to identify the underlying populations and to determine their statistical properties. Such process is often called FMM decomposition, which belongs to signal decomposition. If sampled distribution (probability density or histogram) is given, the SE method described above is readily applicable, treating the distribution as the full signal. In most of FMM decomposition problems in statistics, it is often that a set of discrete random samples are given.

Presently, the dominant method for FMM decomposition problems is the Maximum Likelihood Estimation (MLE) method. Assuming that the discrete random samples are xᵢᵢ (n=1, 2, . . . , N), the corresponding likelihood is given by

L=Πₙ₌₁^{N}m(xₙ)=Πₙ₌₁^{N}[Σₘ₌₁^{M}Aₘfₘ(xₙ,αₘ)] (26)

This likelihood is constructed with the full model, for definiteness it will be called full-model likelihood. The MLE method states that the optimal parameters should maximize the full-model likelihood under the partition constraint in equation (25).

According to the MLE, the optimal parameters can be determined by requiring the derivatives of the log likelihood, 1 mL, with respect to all parameters to vanish under the partition constraint, resulting

$$\{ \begin{matrix}{p}_{rn} = \frac{{A}_{m} {f}_{r} ( {x}_{n} , {α}_{r} )}{m ( {x}_{n} )} \\ {\sum }_{n = 1}^{N} {p}_{rn} \frac{\partial ln {f}_{r} ( {x}_{n} , {α}_{r} )}{\partial {α}_{r}} = 0 \\ {A}_{m} = \frac{1}{N} {\sum }_{n = 1}^{N} {p}_{rn}\end{matrix} , \\ ( r = 1 , 2 , … , M ) \qquad ( 27 )$$

These equations are often called MLE equations in the literature.

Presently, solving the MLE equations is mostly done using the Expectation-Maximization (EM) algorithm. Regardless what method is used for solving the MLE equations, the MLE method requires the full model and the initialization for the parameters. Unfortunately, in most practical problems, the full model and/or the initialization is often not available. The existing methods rely on trails with different full models and/or random initialization. As discussed earlier, such trails are not reliable and fail often, especially when there is strong component interaction.

For discrete random samples, one can compute the distribution (histogram) from the samples and then applies the SE method. The SEEM form of the SE method can also be directly extended to the cases of discrete random samples.

For linear composition of scalar components, using the SEEM in equation (22), we construct the SEEM likelihood

L_{SEEM}=Πₙ₌₁^{N}m_{E}(xₙ)=Πₙ₌₁^{N}{Σₖ₌₁^{K}Aₖ^{(*)}fₖ[xₙ,αₖ^{(*)}]} (28)

The SEEM likelihood differs from the full-model likelihood since SEEM differs from the full model.

The target (adjustable) parameters of the SEEM can be estimated by maximizing the SEEM likelihood, under the constraint

Σₖ₌₁^{K}Aₖ^{(*)}=1 (29)

This constraint differs from that in equation (24) in that the number of considered components (K) of SEEM may differ from the number of component (M) of the full model.

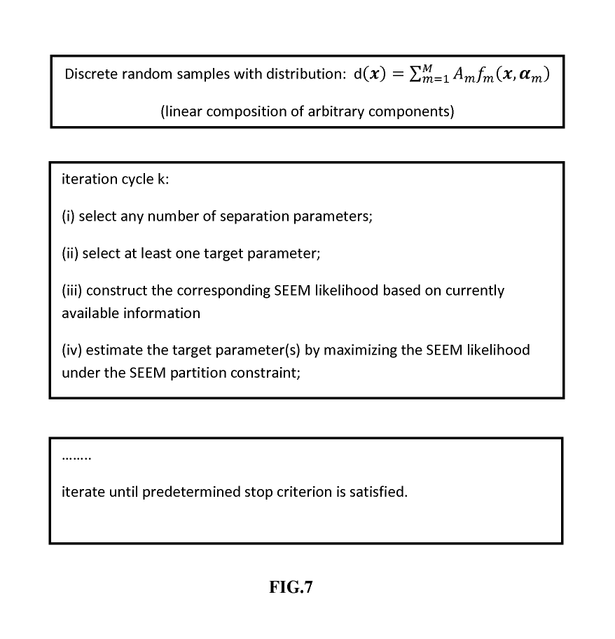

This embodiment of the SE method is listed in FIG. 7. To distinguish from the MLE, this embodiment of the SE method will be called the Separation-Estimation Maximum Likelihood Estimation (SE-MLE) method.

The SEEM likelihood can be directly maximized by requiring the partial derivatives of the log likelihood, lnL_{SEEM}, with respect to all adjustable (target) parameters to vanish under the partition constraint in equation (29), resulting

$$\{ \begin{matrix}{p}_{rn} = \frac{{A}_{r}^{(* )} {f}_{r} [ {x}_{n} , {α}_{r}^{(* )} ]}{{m}_{E} ( {x}_{n} )} \\ {\sum }_{n = 1}^{N} {p}_{rn} \frac{\partial ln {f}_{r} [ {x}_{n} , {α}_{r}^{(* )} ]}{\partial {α}_{ri}^{(* )}} = 0 \\ {A}_{r}^{(* )} = \frac{1}{N} {\sum }_{n = 1}^{N} {p}_{rn}\end{matrix} , \\ [ for all target parameter {α}_{ri}^{(* )} ] \qquad ( 30 )$$

These equations will be called SE-MLE equations, which differ fundamentally from the MLE equations (although they may appear similar). SE-MLE equations may also be solved using the EM algorithm.

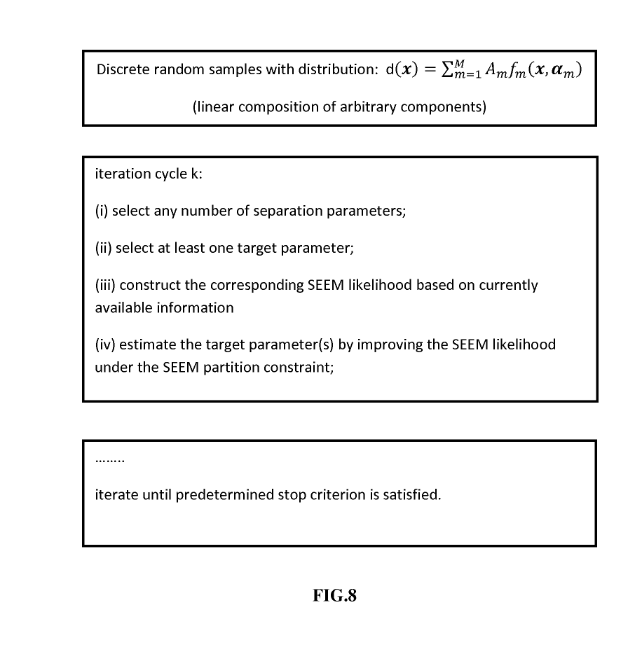

The SE-MLE maximizes the SEEM likelihood in every iteration cycle. The relaxed version requires each iteration cycle improves (increases) the SEEM likelihood but does not necessarily maximize it. The relaxed SE-MLE is listed in FIG. 8. To improve a function, one only needs to find a step at which the function increases its value. But such step does not have to maximize the function. The skilled in the art should know that there many effective methods for such purpose exist, which will not be described here. Obviously, the relaxed SE-MLE is more general than the original SE-MLE (FIG. 7) and the original SE-MLE is a special case of the relaxed SE-MLE, since maximizing SEEM likelihood is a special case of improving it.

Although in principle the SE-MLE and the relaxed SE-MLE do not require a partial signal, it is beneficial to have a partial signal to guide the process. To compute a partial signal, one must have a full signal in the first place. For discrete random samples, candidates for full signal include (but not limited to) SEEM likelihood, distribution (probability density, histogram, etc.), and Prn. Then, in each iteration cycle, one selects desired separation components and computes the corresponding partial signal by removing the contribution of the separation components from the full signal. As explained previously, the partial signal represents (although often approximately) the contribution of the target components and can provide great insight into the target components. An appropriate partial signal can guide us to find new component, to determine the correct component model, and to obtain good initialization for the target parameters.

### The Difference Between the Seem and the Existing Models

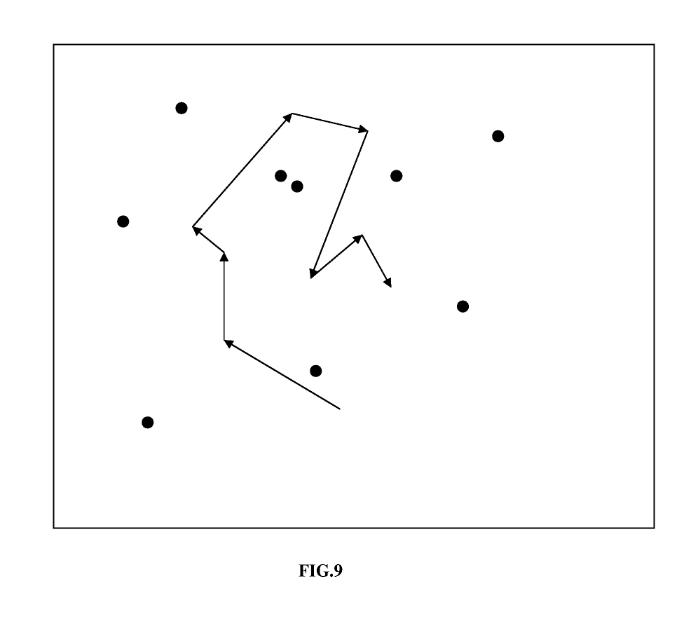

The SEEM differs from all existing models that have been proposed or used in signal decomposition, such as full model or a set of trial full models. In a full model, only the parameters are adjustable. The number of components and the component models are all fixed. In contrast, the SEEM evolves during the signal decomposition process. Not only some of the parameters (target parameters) are adjustable, the number of components and the component models may also change. Some existing signal decomposition methods use a set of trial full models, fit each of them to the full signal, and pick the one with the best fitting. These trial full models are completely independent (with no connection or precedence) from each other. SEEM does not equal to a set of trial models either. The difference between SEEM and a set of trial full modes can be clearly seen in the model space, which is schematically presented in FIG. 9. In the model space (where the number of components, the component models, and the values of the parameters are the coordinates), a set of trial full models are a set of unrelated points (unconnected dots), while SEEM (connected arrows) moves through the model space (the steps of movement are related).

In addition, the full models do not have separation component (or separation parameter), target component (or target parameter). Furthermore, SEEM is built (evolves) via an iterative process. Such an iterative process does not exist in the signal decomposition methods that use one or a set of trial full models.

None of the existing signal decomposition methods, including the CLEAN type algorithms, mentions, defines, or uses SEEM. Furthermore, the CLEAN type algorithms determine each component (complex harmonic oscillation) by FTPPE. As proved previously, FTPPE and the CLEAN type algorithms must process the components in a sequential manner. In contrast, with SEEM one can process any number of target components. In addition, FTPPE and the CLEAN type algorithms do not apply to discrete random samples, but SEEM does apply.

### Performance Enhancement Schemes

In the following we introduce some add-on parts to the SE method. These add-on parts are not essential for the SE method, but they may be used to enhance the performance of the SE method in various ways. The effectiveness of these add-on parts depend on the actual signal decomposition problem.

### Schemes of Weighted Samples

We can give each sample point an appropriate weight. With the weights, the partial objective function becomes

E_{P}=Σₙ₌₁^{N}=wₙe{y_{P}(xₙ),m_{P}(xₙ)} (31)

where wₙ≧0 (n=1, 2, . . . , N) is the a weighting series. The weighting series makes the optimization more flexible. When wₙ=1/N (n=1, 2, . . . , N), the sample points are uniformly weighted or unweighted and the partial objective function in equation (31) reduces to that in equation (16) divided by N (constant N has no effect in optimization process). The partial objective function refers to the general form in equation (31). The weighting series can be dynamic and adaptive: it can vary as the iteration progresses or even vary from iteration cycle to iteration cycle.

Similarly, the objective function with SEEM becomes

E_{P}=Σₙ₌₁^{N}=wₙe{y(xₙ),m_{E}(xₙ)} (32)

The partial objective function with SEEM refers to the general form in equation (32).
The SEEM likelihood becomes

L_{SEEM}=Πₙ₌₁^{N}wₙ{Σₖ₌₁^{K}Aₖ^{(*)}fₖ[xₙ,αₖ^{(*)}]} (33)

When wₙ=1/N(n=1, 2, . . . , N), equation (33) reduces to equation (28) divided by N^{N} (which has no effect on optimization). The SEEM likelihood refers to the general form in equation (33).
The SE-MLE equations become

$$\begin{matrix}\{ \begin{matrix}{p}_{rn} = \frac{{A}_{r}^{(* )} {f}_{r} [ {x}_{n} , {α}_{r}^{(* )} ]}{{m}_{E} ( {x}_{n} )} \\ {\sum }_{n = 1}^{N} {w}_{n} {p}_{rn} \frac{\partial ln {f}_{r} [ {x}_{n} , {α}_{r}^{(* )} ]}{\partial {α}_{ri}^{(* )}} = 0 \\ {A}_{r}^{(* )} = {\sum }_{n = 1}^{N} {w}_{n} {p}_{rn}\end{matrix} , \\ [ for all target parameter {α}_{ri}^{(* )} ] & ( 34 )\end{matrix}$$

When wₙ=1/N(n=1, 2, . . . , N), equation (34) reduces to equation (30). The SE-MLE equations refer to the general form in equation (34).

One useful scheme of weighted samples is Weight By Dominance (WBD): when a particular component is to be estimated, one gives more weights to the sample points where the component dominates, which, in addition to the separation, effectively reduces the influence of other components. WBD is particularly effective in the early stage where the separation is incomplete. WBD can be dynamic and adaptive: as the iteration progresses and the separation becomes more complete, the weight series may be made more uniform.

### Schemes of Weighted Separation Components

We can also give each separation component an appropriate weight. So the partial signal becomes

y_{P}(xₙ)=y(xₙ)D{λₛ_{₁}fₛ_{₁}[xₙ,αₛ_{₁}^{(p)}],λₛ_{₂}fₛ_{₂}[xₙ,αₛ_{₂}^{(p)}], . . . ,λₛ_{_{I}}fₛ_{_{I}}[xₙ,αₛ_{_{I}}^{(p)}]},(n=1,2, . . . ,N) (35)

The weights (λₛ_{₁}, λₛ_{₂}, . . . , λₛ_{_{I}}) give us the flexibility to remove a whole separation component (λ=1), less than it (λ<1) or more than it (λ>1). When all λ=1, the separation components are unweighted and the partial signal in equation (35) reduces to that in equation (13). The partial signal refers to the general form in equation (35). The weights on the separation can also be dynamic and adaptive.

### Schemes of Weighted Target Components

Similarly, we can also give each target component an appropriate weight. So the partial model becomes

mₚ(x)=C{λₜ_{₁}fₜ_{₁}[x,αₜ_{₁}^{(a)}],λₜ_{₂}fₜ_{₂}[x,αₜ_{₂}^{(a)}], . . . ,λₜ_{_{L}}fₜ_{_{L}}[x,αₜ_{_{L}}^{(a)}]} (36)

The numerical multipliers (λₜ_{₁}, λₜ_{₂}, . . . , Aₜ_{_{L}}) in the partial model give us the flexibility to weigh each target component separately. When all λ=1, the partial model in equation (36) reduces to that in equation (14). The partial model refers to the general form in equation (36). The weights on the target components can also be dynamic and adaptive.

With the SEEM, we can give the considered components appropriate weights, so the SEEM becomes

m_{E}(x)=C{λ₁f₁[x,α₁^{(*)}],λ₂f₂[x,α₂^{(*)}], . . . ,λ_{K}f_{K}[x,α_{K}^{(*)}]} (37)

When all λ=1, When all λ=1, the SEEM in equation (37) reduces to that in equation (19). The SEEM refers to the general form in equation (37). The weight can be dynamic and adaptive.

### Schemes of Asymptotic Property Enforcement

Some components may have certain asymptotic properties. For example, strictly convex Gaussian components approach zero far away from its center (mean). Enforce such asymptotic value may add stability. The enforcement can be done by adding the asymptotic value as artificial sample points. For example, for strict convex Gaussian components, one adds some artificial sampling points xₙ, which are far from the center(s) of the target component(s), and assumes the full signal and partial signal to be zero at these artificial sampling points. The artificial sampling points can also be dynamic and adaptive.

### Schemes of Combining the Residuals

As mentioned earlier, the residuals of a component due to inaccurate estimation of the component may appear as (smaller) components. These “child” components should be combined with their “parent” components. Usually, there is one or more identifying parameters, of which the “parent” and the “children” having close values. For example, the identifying parameters for Gaussian components are the mean (the center). The identifying parameters for damped oscillations are the damping constant and the frequency. The identifying parameter for harmonic oscillations is the frequency. If the identifying parameter of a “small” component is close to that of a large component, it is likely that this “small” component is actually the residual of the large component and we combine the small component to the large component.

### Non-Parametric and Semi-Parametric Component Models

The above description mainly focuses on parametric component models where the component model fₘ(x,αₘ) has a set of adjustable parameters αₘ. Estimating a component means to (i) select component model and (ii) adjust the parameters such that the partial model best fits the partial signal (or, with the SEEM form, the SEEM best fits the full signal) according to predetermined criteria.

There are also situations that require the use of non-parametric component models or semi-parametric component models. The reason that the above description mainly concerns parametric component modes is that the non-parametric and semi-parametric component models can be considered as special cases of the parametric component models.

A parametric component model is deformable, namely, it changes form as the parameters change. In contrast, a non-parametric component model has no adjustable parameter hence is rigid. Non-parametric component models are also called categorical component models in the literature. Mathematically, a non-parametric component model fₘ(x) can always be considered as a parametric component model fₘ(x,αₘ) with its parameters fixed at specific values. Therefore, a non-parametric component model can be identified either by the subscript m or by the corresponding fixed αₘ. For non-parametric component models, estimating a component means to select non-parametric component model from a set of available ones such that the partial model best fits the partial signal (or, with the SEEM form, the SEEM best fits the full signal) according to predetermined criteria.

A semi-parametric component model is partially deformable and partially rigid. Mathematically, a semi-parametric component model can be considered as a parametric component model fₘ(x,αₘ) with some of the parameters being adjustable and the others being fixed at specific values. The most common semi-parametric model is Aₘfₘ(x), where only the amplitude Aₘ is adjustable. For semi-parametric component models, estimating a component means to (i) select non-parametric part from a set of available ones and (ii) adjust the adjustable parameters such that the partial model best fits the partial signal (or, with the SEEM form, the SEEM best fits the full signal) according to predetermined criteria.

Since non-parametric component model and semi-parametric component model are special cases of parametric model, the SE method described above for parametric component models apply to all types of component models.

### The Scope and the Advantages of the SE Method

In summary, the SE method has the following important advantages over the existing signal decomposition methods.

(A1) The SE method can handle signals of arbitrary form (scalar, vector, tensor, real, complex, etc.);
(A2) The SE method can handle signals of arbitrary composition;
(A3) The SE method can handle signals composed of arbitrary components;
(A4) The SE method can estimate simultaneously multiple (target) components;
(A5) The SE method can systematically and reliably complete all four tasks (T1)-(T4) of signal decomposition;
(A6) The SE method can handle strong component interaction;
(A7) The SE method can be easily tailored to handle a broad range of signal decomposition problems.

The SE method is extremely flexible and can be tailored in countless ways. With the freedom of selecting the separation components and target components, each iteration cycle can be different. One can choose to estimate or re-estimate any component at any iteration cycle. The estimation can be rough or accurate. One can choose to estimate and re-estimate one component at a time, several components at a time, or all detected components together. The procedure can also be divided into several stages. All such specific tailoring and adopting for specific signal decomposition problem are within the scope of the SE method.

Because the existing signal decomposition methods as a whole have severe limitations, many of the signal decomposition problems remain unsolvable. Some of these problems are even not considered as signal decomposition problems. Since the SE method has a much broader scope and is of much great capability. The skilled in the art in various fields should realize that many problems in their fields can now be classified as signal decomposition problem and many unsolvable signal decomposition problems now can be solved by the SE method.

It should be emphasized once more that signal decomposition does not necessarily mean to determine all underlying components, to determine all aspects of the underlying components, or to pursue maximum accuracy or absolute convergence. The specific requirements depend on the specific problem and the specific objective. Some cases required all components be determined, while some other cases require only a subset of the component be determined. Some cases require accurate estimation of the components, while some other cases require only rough estimation of the components. Some cases may require accurate estimation of some components and rough estimation of other components. Some cases may require accurate estimation of some parameters and rough estimation of other parameters. Some cases may only require certain components be detected.

The fundamental idea and spirit (separation-estimation), the essential elements (e.g., composition operator, decomposition operator, separation component (parameter), target component (parameter), partial signal, partial model, SEEM, SEEM likelihood), and the essential procedure can be used to solve a broad range of problems which are of the nature of signal decomposition. Therefore, the skilled in the art should appreciate that the use of the fundamental idea and spirit, the essential elements, the essential procedure in a specific form, to certain extends, for a specific problem of a specific field should not be considered as a new use but a mere application of the SE method.

What is claimed is:

1. An iterative method for decomposing signals of arbitrary composition of arbitrary components excluding LCCHO, wherein an iteration cycle comprising the steps:
(a) selecting any number of separation components;
(b) computing the corresponding partial signal;
(c) selecting at least one target component;
(d) constructing the corresponding partial model;
(e) estimating said target component(s) by fitting said partial model to said partial signal;
said iteration stopping when a predetermined stop criterion is met.

2. The method of claim 1 wherein said estimation in at least one of said iteration cycles is done via an optimization process.

3. The method of claim 1 wherein a suitable scheme of weighted samples is further used.

4. The method of claim 1 wherein WBD is further used.

5. The method of claim 1 wherein a suitable scheme of asymptotic property enforcement is further used.

6. The method of claim 1 wherein a suitable scheme of combining the residuals is further used.

7. The method of claim 1 wherein at least one of said components is a damped oscillation.

8. The method of claim 1 wherein at least one of said components is a Gaussian.

9. The method of claim 1 wherein at least one of said components is a real harmonic oscillation.

10. The method of claim 1 wherein at least one of said components is a real harmonic oscillation.

11. An iterative method for decomposing signals of arbitrary composition of arbitrary components, wherein an iteration cycle comprising the steps:
(a) selecting any number of separation parameters;
(b) selecting at least one target parameter;
(c) constructing the SEEM based on currently available information;
(d) utilizing the full signal to estimate said target parameter(s);
said iteration stopping when a predetermined stop criterion is met.

12. The method of claim 11 wherein said estimation in at least one of said iteration cycles is done via an optimization process.

13. The method of claim 11 wherein a suitable scheme of weighted samples is further used.

14. The method of claim 11 wherein a suitable partial signal is further computed to guide the process.

15. The method of claim 11 wherein WBD is further used.

16. The method of claim 11 wherein a suitable scheme of asymptotic property enforcement is further used.

17. The method of claim 11 wherein at least one of said components is selected from a group consisting harmonic oscillation, damped oscillation, and Gaussian.

18. An iterative method for decomposing discrete samples having mixture distribution, wherein an iteration cycle comprising the steps:
(a) selecting any number of separation parameters;
(b) selecting at least one target parameter;
(c) constructing the SEEM likelihood based on currently available information;
(d) estimating said target parameter(s) by improving said SEEM likelihood under partition constraint;
said iteration stopping when a predetermined stop criterion is met.

19. The method of claim 18 wherein a suitable partial signal is further computed to guide the process.

20. The method of claim 18 wherein said SEEM likelihood is maximized in at least one of said iteration cycles.
